(19) United States
(12) Patent Application Publication
(10) Pub. No.: US 2021/0259259 A1
(43) Pub. Date: Aug. 26, 2021

(54) FOOD CUTTING DEVICE

(71) Applicants: John D. Axtell, Summit, NJ (US); Amanda N. Axtell, New Providence, NJ (US); Terri Axtell, New Providence, NJ (US)

(72) Inventors: John D. Axtell, Summit, NJ (US); Amanda N. Axtell, New Providence, NJ (US); Terri Axtell, New Providence, NJ (US)

(21) Appl. No.: 17/187,665

(22) Filed: Feb. 26, 2021

Related U.S. Application Data
(60) Provisional application No. 62/981,886, filed on Feb. 26, 2020.

(51) Int. Cl. A21C 15/04; A47J 47/08

(52) U.S. Cl. CPC A21C 15/04; A47J 47/08

(57) ABSTRACT

A food cutting assembly is described. The food cutting assembly includes a bowl that houses a food product, a food cutting device configured to fit inside of the bowl and cut the food product, and a cover unit configured to engage an opening of the bowl to form a closed container. The food cutting device includes a support structure defining an aperture therein, cutting members located within the support structure and arranged in a shape across the aperture to define sections between the cutting members, and one or more handles affixed to the support structure. The cutting members are co-planar with the support structure.

### RELATED APPLICATIONS

This is a non-provisional application of provisional Application No. 62/981,886 filed Feb. 26, 2020. The disclosures of the prior application is hereby incorporated by reference herein in its entirety.

### FIELD OF THE EMBODIMENTS

The field of the invention and its embodiments relate to food cutting devices and food cutting assemblies. In particular, the present invention and its embodiments provide a child-safe food cutting device and a food cutting assembly that easily cuts a cooked food product into equally sized and shaped portions.

### BACKGROUND OF THE EMBODIMENTS

Numerous household consumer items exist, which assist in the cutting of both cooked and uncooked food products. Examples of such household consumer items include salad slicers and apple wedgers, among others, which utilize highly sharpened cutting blades to cut or divide the food product into smaller-sized portions having a similar or identical shape and size. For example, an apple wedger may be used to cut fruits or vegetables into similar or identical shaped and sized wedges. The apple wedger may include a slicer portion and a handle. The slicer portion may have a peripheral frame structure and internal cutting blades. A user may engage with the handle to push food items through the gaps between cutting blades.

As another example, a salad slicer may include a salad bowl having an upper rim and a mandoline slicer. The mandoline slicer may fit on the upper rim of the salad bowl and may include a main platform along which food is to be slid by the user and a cutting tool disposable in the main platform, with a space adjacent the cutting edge of the tool. When food is slid across the main platform, the cutting edge removes a quantity of the food, which falls through the space and into the salad bowl.

Based on the configuration of the cutting blades employed in these food cutting devices, a great deal of force must be exerted by the user on the food cutting device to slice the food product. Further, these devices are dangerous and cannot be used by children, as the blades may severely injure the user if the device and/or the food product slips while the user is attempting to slice the food product. Moreover, the user may engage with the food cutting device numerous times to cut the food product into the desired shapes and sizes. As such, these food cutting devices make the cutting of food products quite time consuming.

Furthermore, as an alternative to these food cutting devices, a knife can be used. However, the same drawbacks associated with the blades of the food cutting devices are seen with use of a knife. Thus, a need exists for a child-safe food cutting device or food cutting assembly that quickly and easily cuts a food product into equally sized and shaped portions.

### REVIEW OF RELATED TECHNOLOGY

U.S. Pat. No. 9,630,334 B2 describes a circular food cutting assembly. The food assembly includes an outer ring that has an inner surface, an outer surface, and a bottom edge comprising a blade. A pair of handles are attached to the outer surface. Cutting members are attached to and extend between the outer ring and an inner ring such that the inner ring is coaxial with the outer ring. Each of the cutting members has a lower edge comprising a blade. The lower edges of the cutting members and the bottom edge are co-planar. An intermediate ring has a first edge and a second edge positioned opposite each other, such that the second edge is directed downwardly and comprises a blade. The intermediate ring is removably attached to the cutting members, such that the second edge is co-planar with the lower edges.

U.S. Pat. No. 8,726,521 B2 describes an apple wedger for cutting fruits or vegetables into wedges. The apple wedger includes a slicer and a pusher/handle. The slicer has a peripheral frame and internal cutting blades. A user may engage with the pusher/handle to push food items through the gaps between cutting blades. In some versions, the pusher/handle is pivotally attached to the slicer.

U.S. Patent Application Publication No. 2018/0339417 A1 describes an assembly for slicing a food item. The assembly includes a plate selectively positioned on a support surface. A plurality of pegs are provided and each of the pegs is coupled to and extends upwardly from the plate. A food item is placed on each of the pegs. Moreover, the plurality of pegs space the food item from the plate thereby facilitating the food slicer to slice fully through the food item.

EP 2,087,969 B1 describes a food cutting device. The device includes a frame defining an aperture therein and cutting blades located within the frame across the aperture. The cutting blades are arranged in a lattice structure and have cutting edges facing in a common cutting direction. At least some of the cutting blades intercept with one another at certain intercepting positions and include portions between at least some of the intercepting positions having reduced blade-making material so as to reduce the area of contact of the cutting blades with food when the latter is being cut.

EP 2,090,410 A1 describes a food cutting device that includes a body frame defining an aperture therein and a cutter removably located within the aperture. The body frame has a first engaging formation (e.g., an L-shaped slot). The cutter has a second engaging formation (e.g., a protrusion) that is located adjacent and releasably engages with the slot for connecting the cutter to the body frame.

U.S. Pat. No. 7,086,155 B2 describes an apparatus for coring and slicing a food item. The apparatus includes a peripheral member, a coring element, and blades extending radially from the coring element to the peripheral member in spaced relation about the coring element. The apparatus may be combined with a base for securing the food item.

Various references describe attempts at remedying the difficulties associated with providing a child-safe solution to cutting a cooked food product without use of a knife. However, a need exists for a child-safe food cutting device or a food cutting assembly that easily cuts a cooked food product into equally sized and shaped portions.

### SUMMARY OF THE EMBODIMENTS

The present invention and its embodiments relate to food cutting devices and food cutting assemblies. In particular, the present invention and its embodiments provide a child-safe food cutting device and a food cutting assembly that easily cuts a cooked food product into equally sized and shaped portions.

In a first embodiment, a food cutting device is described. The food cutting device may comprise: a plastic material, a metal material, a wood material, a composite material, a glass material, and/or a resin material. The food cutting device may include a support structure defining an aperture therein. The support structure may comprise a shape that includes at least one circular arc, such as: a circular shape, a substantially circular shape, a crescent shape, and a semicircular shape. In other examples, the support structure may include a shape selected from the group consisting of: a rectangular shape, a henagonal shape, a diagonal shape, a triangular shape, a quadrilateral shape, a pentagonal shape, a hexagonal shape, a heptagonal shape, an octagonal shape, a nonagonal shape, a decagonal shape, a hendecagonal shape, a dodecagonal shape, a tridecagonal shape, a tetradecagonal shape, a pentadecagonal shape, a hexadecagonal shape, a heptadecagonal shape, an octadecagonal shape, an enneadecagonal shape, and an icosagonal shape. In some examples, an area of the support structure is in a range of approximately 6 inches to approximately 9 inches. In other examples, an area of the support structure is in a range of approximately 3 inches to approximately 6 inches.

The food cutting device may also include cutting members located within the support structure and arranged in a shape across the aperture to define sections between the cutting members. The cutting members may be located co-planar with the support structure in a first plane. In an example, the shape of the cutting members across the aperture is a lattice shape formed by a first portion of the cutting members intersecting with a second portion of the cutting members. In further examples, each member of the cutting members may comprise a blade facing in a common direction. According to some examples, each section of the sections between the cutting members has an area of approximately 1 inch.

The food cutting device may also include one or more handles affixed to the support structure. In some examples, the one or more handles include a first handle and a second handle. The first handle is affixed to the support structure at a first location. The second handle is affixed to the support structure at a second location. The second location is located opposite the first location. The first handle and the second handle are located in a second plane elevated from the first plane. In other examples, the one or more handles include a singular handle extending horizontally in a second plane elevated from the first plane, and configured to contact the support structure at a first location and at a second location, the first location is disposed opposite the second location.

In a second embodiment, a food cutting assembly is described. The food cutting assembly may include a bowl configured to house a food product. The food product may be a cooked food product, such as a cooked pasta product. In some examples, a diameter of the bowl is approximately 11 inches to approximately 14 inches. In other examples, a diameter of the bowl is approximately 8 inches to approximately 11 inches. In some examples, a depth of the bowl is approximately 2 inches to approximately 5 inches.

The food cutting assembly may also include a food cutting device configured to fit inside of the bowl and cut the food product. The food cutting device may include a peripheral frame structure (or a support structure) having a circular or a substantially circular shape and defining an aperture therein. The food cutting device may also include cutting members located within the peripheral frame structure and arranged in a shape across the aperture to define sections between the cutting members. The cutting members may be located co-planar with the peripheral frame structure in a first plane.

The food cutting assembly may also include one or more handles affixed to the peripheral frame structure. In some examples, the one or more handles include a first handle and a second handle. The first handle is affixed to the peripheral frame structure at a first location. The second handle is affixed to the peripheral frame structure at a second location. The second location is located opposite the first location. The first handle and the second handle are located in a second plane elevated from the first plane. In other examples, the one or more handles include a singular handle extending horizontally in a second plane elevated from the first plane, and configured to contact the peripheral frame structure at a first location and at a second location, the first location is disposed opposite the second location.

The food cutting assembly may further include a cover unit comprising a first side disposed opposite a second side, where the second side is configured to engage an opening of the bowl to form a closed container. The cover unit may also include a third handle affixed to the first side.

In a third embodiment, a method to cut a food product using a food cutting device is described. The food cutting device may comprise a peripheral frame structure defining an aperture therein and cutting members located within the peripheral frame structure and arranged in a lattice configuration across the aperture to define sections between the cutting members. The cutting members may be located co-planar with the peripheral frame structure in a first plane.

The food cutting device may also include one or more handles affixed to the peripheral frame structure. In some examples, the one or more handles include a first handle and a second handle. The first handle is affixed to the peripheral frame structure at a first location. The second handle is affixed to the peripheral frame structure at a second location. The second location is located opposite the first location. The first handle and the second handle are located in a second plane elevated from the first plane. In other examples, the one or more handles include a singular handle extending horizontally in a second plane elevated from the first plane, and configured to contact the peripheral frame structure at a first location and at a second location, the first location is disposed opposite the second location.

The method may include several process steps, such as: placing, by a user, a food product, such as a cooked food product, onto a plate; and engaging, by the user, the first handle and the second handle to push the food cutting device into the food product such that the cutting members cut the food product into pieces. The pieces may have an area of approximately 1 inch to approximately 2 inches.

In general, the present invention succeeds in conferring the following benefits and objectives.

It is an object of the present invention to provide a food cutting device and/or food cutting assembly that allows a user to quickly cut a cooked food product into even and equally sized portions.

It is an object of the present invention to provide a food cutting device and/or food cutting assembly that allows a user to conveniently cut a cooked food product into even and equally sized portions.

It is an object of the present invention to provide a safe and child-proof food cutting device and/or food cutting assembly that allows a child to quickly and conveniently cut a cooked food product into even and equally sized portions, without the need for adult supervision.

### BRIEF DESCRIPTION OF THE DRAWINGS

FIG. 1 is a perspective view of a food cutting assembly, according to at least some embodiments described herein.

FIG. 2 is another perspective view of a food cutting assembly, according to at least some embodiments described herein.

FIG. 3 is a top view of a first embodiment of a food cutting device, according to at least some embodiments described herein.

FIG. 4 is another perspective view of a food cutting assembly, according to at least some embodiments described herein.

FIG. 5 is a top perspective view of a second embodiment of a food cutting device, according to at least some embodiments described herein.

FIG. 6 is a bottom perspective view of a second embodiment of a food cutting device, according to at least some embodiments described herein.

FIG. 7 is a top down view of a second embodiment of a food cutting device, according to at least some embodiments described herein.

FIG. 8 is a side perspective view of a second embodiment of a food cutting device, according to at least some embodiments described herein.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

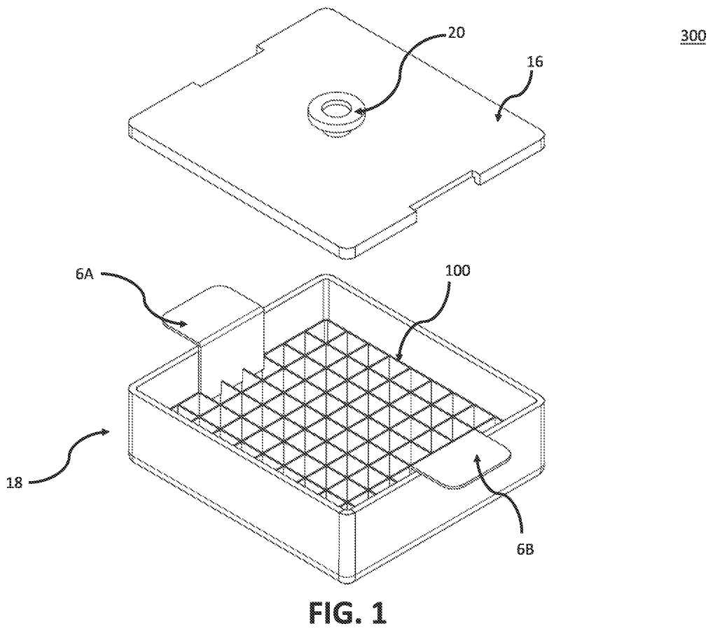

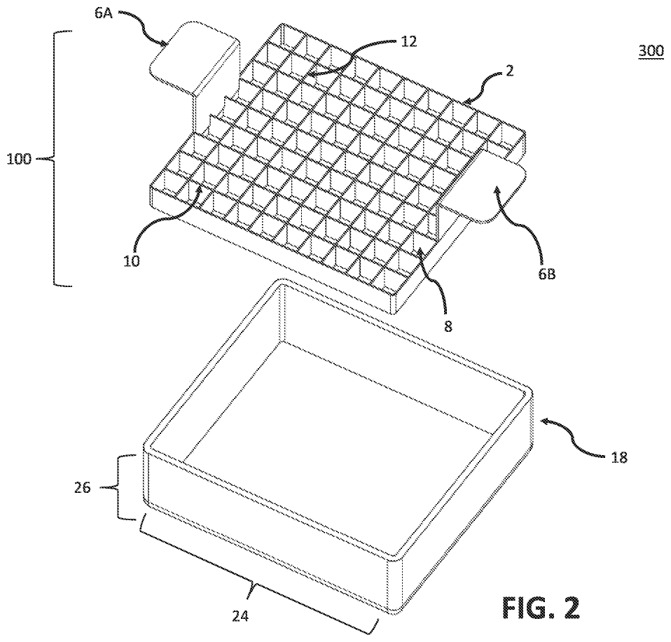

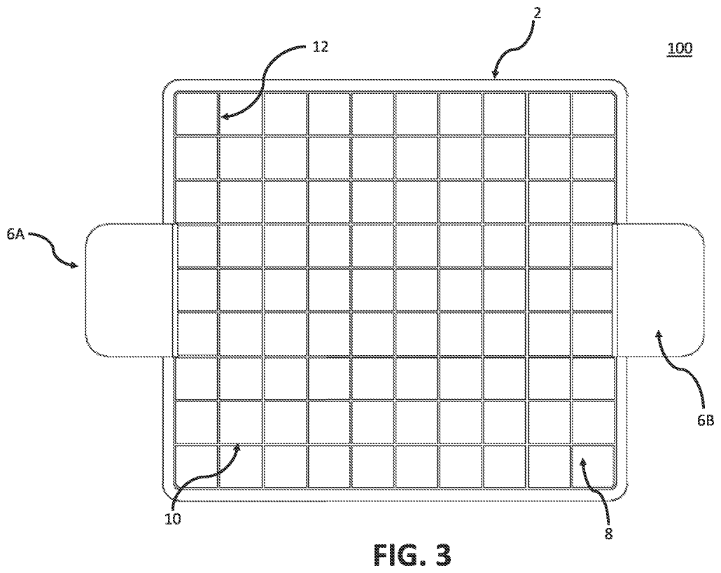

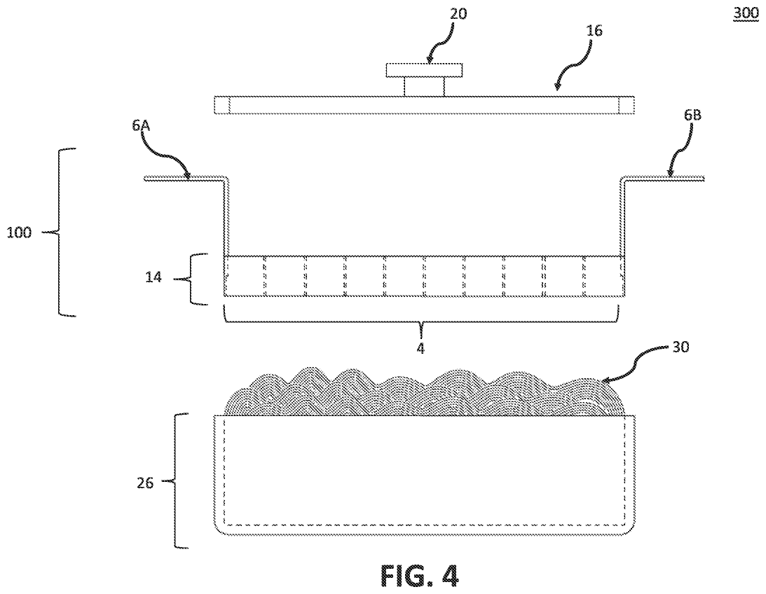

A first embodiment of a food cutting device 100 is depicted in FIG. 1, FIG. 2, FIG. 3, and FIG. 4. In some examples, the food cutting device 100 is configured to cut a food product 30 (as depicted in FIG. 4) into pieces or portions of equal shape and size. The food product 30 may be a cooked or an uncooked food product. In preferred examples, the food product 30 is a cooked pasta food product. It should be appreciated that other food products are contemplated by the embodiments described herein and the food product 30 is not limited to the products explicitly described.

The food cutting device 100 may comprise a plastic material, a metal material, a wood material, a composite material, a glass material, and/or a resin material. The food cutting device 100 may comprise a peripheral frame structure 2 defining an aperture therein. In some examples, the peripheral frame structure 2 may have a shape that includes at least one arc. For example, the peripheral frame structure 2 may have a circular shape, a substantially circular shape, a crescent shape, or a semicircular shape. In other examples, the peripheral frame structure 2 may have a shape that does not include the at least one arc. In these examples, the shape of the peripheral frame structure 2 may be: a rectangular shape, a henagonal shape, a diagonal shape, a triangular shape, a quadrilateral shape, a pentagonal shape, a hexagonal shape, a heptagonal shape, an octagonal shape, a nonagonal shape, a decagonal shape, a hendecagonal shape, a dodecagonal shape, a tridecagonal shape, a tetradecagonal shape, a pentadecagonal shape, a hexadecagonal shape, a heptadecagonal shape, an octadecagonal shape, an enneadecagonal shape, or an icosagonal shape. It should be appreciated that the shape of the peripheral frame structure 2 is not limited to the shapes explicitly described herein and other shapes are contemplated. In other examples, an area 4 (as depicted in FIG. 4) of the peripheral frame structure 2 is in a range of approximately 6 inches to approximately 9 inches. In additional examples, the area 4 (as depicted in FIG. 4) of the peripheral frame structure 2 is in a range of approximately 3 inches to approximately 6 inches.

The food cutting device 100 may also include cutting members 10, 12, located within the peripheral frame structure 2 and arranged in a shape across the aperture to define sections 8 between the cutting members, 10, 12 (as depicted in FIG. 2 and FIG. 3). The cutting member 10, 12 may comprise: a plastic material, a metal material, a wood material, a composite material, a glass material, and/or a resin material. In some examples, the shape of the cutting members 10, 12 across the aperture is a lattice shape formed by a first portion of the cutting members intersecting with a second portion of the cutting members. The cutting members 10, 12 may be located co-planar with the peripheral frame structure 2 in a first plane. In further examples, each member of the cutting members 10, 12 may comprise a blade 14 (of FIG. 4) facing in a common direction. The blade 14 may comprise a child-safe material, such as a plastic material, a metal material, a wood material, a composite material, a glass material, and/or a resin material. As such, the user who engages with the food cutting device 100 may be a child or an adult. In examples, each section of the sections 8 between the cutting members 10, 12 has an area of approximately 1 inch.

The first embodiment of the food cutting device 100 may also include a first handle 6A affixed to the peripheral frame structure 2 at a first location and a second handle 6B affixed to the peripheral frame structure 2 at a second location, where the second location is located opposite the first location (as depicted in FIG. 1, FIG. 2, FIG. 3, and FIG. 4). The first handle 6A and the second handle 6B are located in a second plane elevated from the first plane to provide enhanced leverage for a user to push the food cutting device 100 into the food product 30 to cut the food product 30 into pieces of equal shape and size.

It should be appreciated that the material comprising the food cutting device 100, the cutting members 10, 12, and the blade 14 are not limited to the materials explicitly described herein and other materials are contemplated.

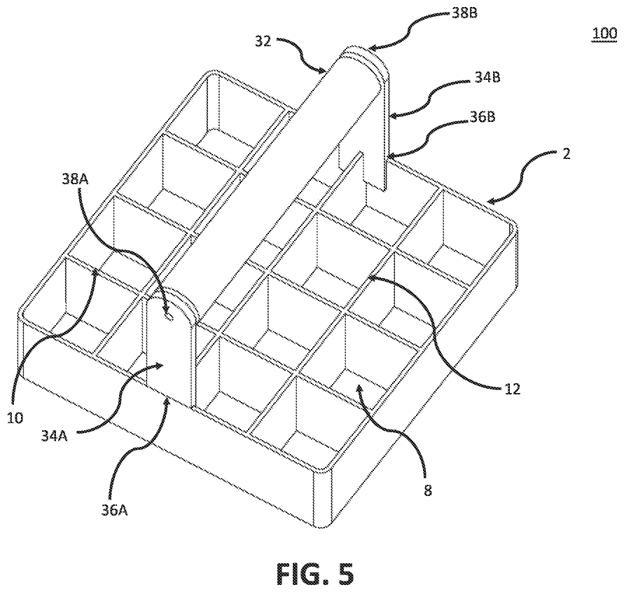

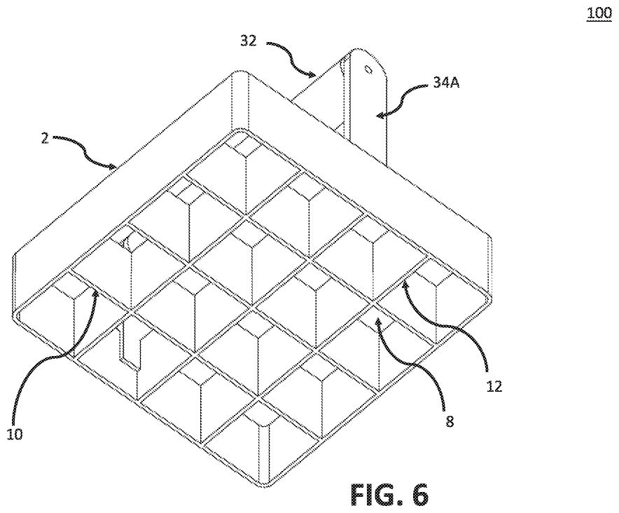

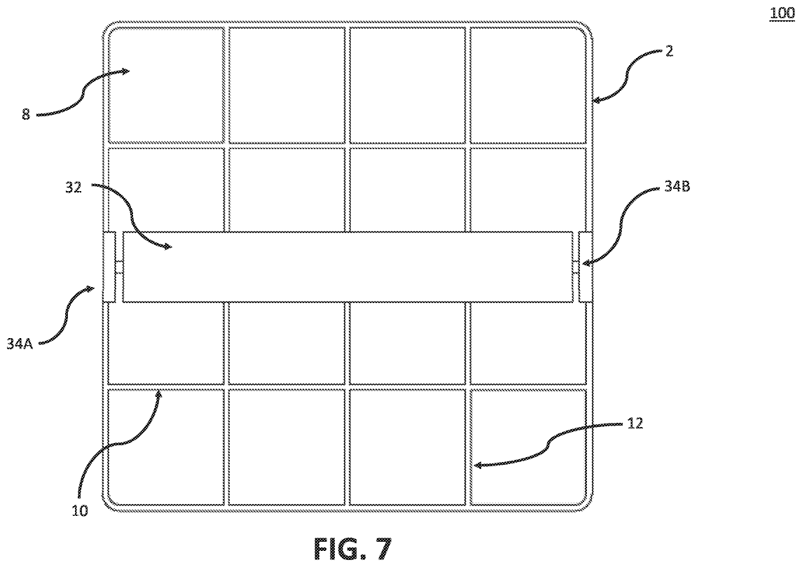

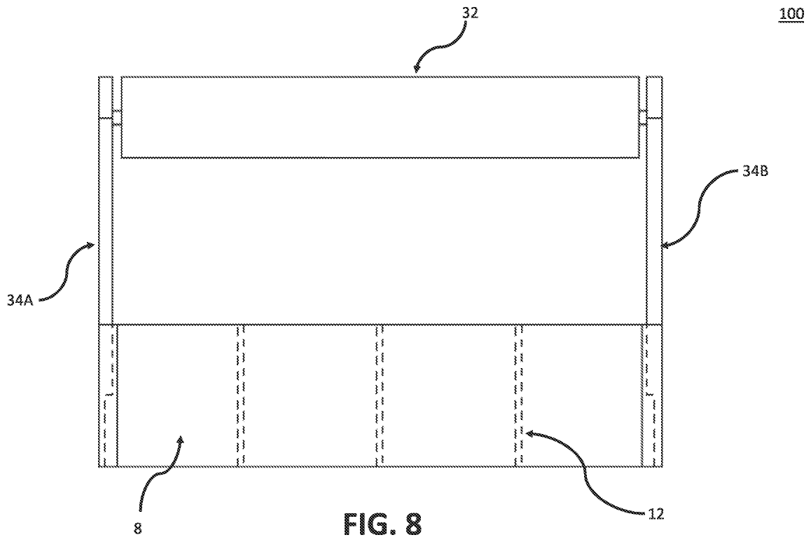

A second embodiment of the food cutting device 100 is depicted in FIG. 5, FIG. 6, FIG. 7, and FIG. 8. It should be appreciated that the second embodiment of the food cutting device 100 is substantially similar to the first embodiment of the food cutting device 100. As explained supra, the food cutting device 100 comprises a peripheral frame structure 2 defining an aperture therein. The food cutting device 100 also includes cutting members 10, 12 located within the peripheral frame structure 2 and arranged in a lattice configuration across the aperture to define sections 8 between the cutting members 10, 12. The cutting members 10, 12 may be located co-planar with the peripheral frame structure 2 in a first plane.

The food cutting device 100, as depicted in FIG. 5, may further include a first component 34A having a first side disposed opposite a second side and a second component 34B having a first side disposed opposite a second side. The first side of the first component 34A may be affixed to the peripheral frame structure 2 at a first location 36A. The first side of the second component 34B may be affixed to the peripheral frame structure 2 at a second location 36B. It should be appreciated that the first location 36A is disposed opposite the second location 36B.

Moreover, the first component 34A and the second component 34B may be configured to extend vertically in a direction opposite the direction of the blade 14 and may be located in a second plane elevated from the first plane. Furthermore, the second embodiment of the food cutting device 100 may also include a handle 32 extending horizontally in a third plane elevated from the second plane. The handle 32 may be substantially circular in shape/configuration, in some examples. The handle 32 may have a first side disposed opposite a second side. The second side of the first component 34A may be affixed to the first side of the handle 32 at a first location 38A. The second side of the second component 34B may be affixed to the second side of the handle 32 at a second location 38B, where the first location 38A is disposed opposite the second location 38B.

According to some examples, the user may place the food product 30, such as a cooked pasta product (as depicted in FIG. 4) on a plate (not shown). The plate (not shown) may be located on a horizontal surface. Assuming that the food cutting device 100 is of the first embodiment, the user may place his/her hands on the first handle 6A and the second handle 6B, respectively. Assuming that the food cutting device 100 is of the second embodiment, the user may place his/her hands on the handle 32. The user may then push the food cutting device 100 into the food product 30 such that the cutting members 10, 12 cut the food product 30 into pieces. The size and shape of the pieces of the food product 30 may be defined by the size and shape of the sections 8 between the cutting members 10, 12.

In an example where each section of the sections 8 between the cutting members 10, 12 has an area of approximately 1 inch, the pieces of the food product 30 may be approximately 1 inch in area. In another example where each section of the sections 8 between the cutting members 10, 12 has an area of approximately 2 inches, the pieces of the food product 30 may be approximately 2 inches in area.

In an example, the cutting members 10, 12 located within the peripheral frame structure 2 may be arranged in a lattice configuration across the aperture to define sections 8 between the cutting members 10, 12 such that each of the sections 8 is rectangular in shape. In this example, the shape of the pieces of the food product 30 are rectangular. In another example, the cutting members 10, 12 located within the peripheral frame structure 2 may be arranged in a configuration across the aperture to define sections 8 between the cutting members 10, 12 such that each of the sections 8 are triangular in shape. In this example, the shape of the pieces of the food product 30 are triangular. In a further example, the cutting members 10, 12 located within the peripheral frame structure 2 may be arranged in a configuration across the aperture to define sections 8 between the cutting members 10, 12 such that each of the sections 8 are circular in shape. In this example, the shape of the pieces of the food product 30 are circular. It should be appreciated that the size and shape of each of the sections 8, as well as the size and shape of the pieces of the food product 30, is not limited to the examples explicitly described herein.

The first embodiment of the food cutting device 100 and/or the second embodiment of the food cutting device 100 may be used in a food cutting assembly 300, as depicted in FIG. 1, FIG. 2, and FIG. 4. As shown in FIG. 1, FIG. 2, and FIG. 4, the food cutting assembly 300 may include a bowl 18, a cover unit 16, and the first embodiment or the second embodiment of the food cutting device 100. The food cutting device 100 may be housed within the bowl 18. The bowl 18 may be configured to house a food product 30, such as a cooked pasta product (as depicted in FIG. 4).

As depicted in FIG. 2, a diameter 24 of the bowl 18 is approximately 11 inches to approximately 14 inches. In other examples, the diameter 24 of the bowl 18 is approximately 8 inches to approximately 11 inches. In additional examples, a depth 26 of the bowl 18 is approximately 2 inches to approximately 5 inches.

The cover unit 16 may comprise a first side disposed opposite a second side. The second side may be configured to engage an opening of the bowl 18 to form a closed container to keep the food product 30 (housed within the bowl 18) at a warm or hot temperature. The cover unit 16 may also include a handle 20 affixed to the first side of the cover unit 16. A user may engage with the handle 20 to affix the cover unit 16 to the bowl 18 or remove the cover unit 16 from the bowl 18.

In examples, the user may place the bowl 18 on a horizontal surface. The user may then place a food product 30 into the bowl 18. Assuming that the food cutting device 100 is of the first embodiment, the user may place his/her hands on the first handle 6A and the second handle 6B, respectively. Assuming that the food cutting device 100 is of the second embodiment, the user may place his/her hands on the handle 32. The user may then push the food cutting device 100 into the food product 30 such that the cutting members 10, 12 cut the food product 30 into pieces. The size and shape of the pieces of the food product 30 may be defined by the size and shape of the sections 8 between the cutting members 10, 12.

To ensure a temperature of the food product 30 does not decrease, the user may engage the cover unit 16 with the bowl 18. Specifically, the user may engage the second side of the cover unit 16 with the opening of the bowl 18 to form the closed container to keep the food product 30 (housed within the bowl 18) at the warm or hot temperature. When the user wishes to remove the food product 30 from the closed container, the user may engage the third handle 20 affixed to the first side of the cover unit 16 to remove the cover unit 16 from the closed container.

When introducing elements of the present disclosure or the embodiments thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A food cutting device comprising:
a support structure defining an aperture therein;
cutting members located within the support structure and arranged in a shape across the aperture to define sections between the cutting members, wherein the cutting members are located co-planar with the support structure in a first plane; and
one or more handles affixed to the support structure.

2. The food cutting device of claim 1, wherein the support structure has a shape comprising: a circular shape, a substantially circular shape, a crescent shape, a semicircular shape, a rectangular shape, a henagonal shape, a diagonal shape, a triangular shape, a quadrilateral shape, a pentagonal shape, a hexagonal shape, a heptagonal shape, an octagonal shape, a nonagonal shape, a decagonal shape, a hendecagonal shape, a dodecagonal shape, a tridecagonal shape, a tetradecagonal shape, a pentadecagonal shape, a hexadecagonal shape, a heptadecagonal shape, an octadecagonal shape, an enneadecagonal shape, and an icosagonal shape.

3. The food cutting device of claim 1,
wherein the one or more handles comprise a first handle and a second handle,
wherein the first handle is affixed to the support structure at a first location,
wherein the second handle is affixed to the support structure at a second location, the second location being located opposite the first location, and
wherein the first handle and the second handle are located in a second plane elevated from the first plane.

4. The food cutting device of claim 1,
wherein the one or more handles include a singular handle extending horizontally in a second plane elevated from the first plane, and configured to contact the support structure at a first location and at a second location, and
wherein the first location is disposed opposite the second location.

5. The food cutting device of claim 1, wherein the food cutting device comprises a material selected from the group consisting of: a plastic material, a metal material, a wood material, a composite material, a glass material, and a resin material, among combinations thereof.

6. The food cutting device of claim 1, wherein the shape of the cutting members across the aperture is a lattice shape formed by a first portion of the cutting members intersecting with a second portion of the cutting members, and wherein each section of the sections between the cutting members has an area of approximately 1 inch.

7. The food cutting device of claim 1, wherein each member of the cutting members comprises a blade facing in a common direction.

8. The food cutting device of claim 1, wherein an area of the support structure is in a range of approximately 6 inches to approximately 9 inches.

9. The food cutting device of claim 1, wherein an area of the support structure is in a range of approximately 3 inches to approximately 6 inches.

10. A food cutting assembly comprising:
a bowl configured to house a food product;
a food cutting device configured to fit inside of the bowl and cut the food product, the food cutting device comprising:
a peripheral frame structure defining an aperture therein;
cutting members located within the peripheral frame structure and arranged in a shape across the aperture to define sections between the cutting members, wherein the cutting members are located co-planar with the peripheral frame in a first plane; and
one or more handles affixed to the peripheral frame structure;
a cover unit comprising a first side disposed opposite a second side, the second side configured to engage an opening of the bowl to form a closed container.

11. The food cutting assembly of claim 10,
wherein the one or more handles comprise a first handle and a second handle,
wherein the first handle is affixed to the peripheral frame structure at a first location,
wherein the second handle is affixed to the peripheral frame structure at a second location, the second location being located opposite the first location, and
wherein the first handle and the second handle are located in a second plane elevated from the first plane.

12. The food cutting assembly of claim 10,
wherein the one or more handles include a singular handle extending horizontally in a second plane elevated from the first plane, and configured to contact the peripheral frame structure at a first location and at a second location, and
wherein the first location is disposed opposite the second location.

13. The food cutting assembly of claim 10, wherein a diameter of the bowl is approximately 11 inches to approximately 14 inches.

14. The food cutting assembly of claim 10, wherein a diameter of the bowl is approximately 8 inches to approximately 11 inches.

15. The food cutting assembly of claim 10, wherein the cover unit further comprises a third handle affixed to the first side, and wherein a depth of the bowl is approximately 2 inches to approximately 5 inches.

16. The food cutting assembly of claim 10, wherein the peripheral frame structure of the food cutting device has a shape selected from the group consisting of: a circular shape and a substantially circular shape.

17. The food cutting assembly of claim 10,
wherein the food product is a cooked food product, and
wherein the cooked food product is a cooked pasta.

18. A method to cut a food product using a food cutting device, the food cutting device comprising a peripheral frame structure defining an aperture therein, cutting members located within the peripheral frame structure and arranged in a lattice configuration across the aperture to define sections between the cutting members, one or more handles affixed to the peripheral frame structure, the cutting members being located co-planar with the peripheral frame structure in a first plane, the method comprising:
placing, by a user, a food product onto a plate; and
engaging, by the user, the first handle and the second handle to push the food cutting device into the food product such that the cutting members cut the food product into pieces, wherein the food product is a cooked food product.

19. The method to cut a food product using a food cutting device of claim 18, wherein the pieces have an area of approximately 1 inch to approximately 2 inches.

20. The method to cut a food product using a food cutting device of claim 18, wherein the food product is a cooked food product.
